(19) United States
(12) Patent Application Publication
(10) Pub. No.: US 2007/0091585 A1
(43) Pub. Date: Apr. 26, 2007

(54) Landscape lighting and fluid delivery system

(76) Inventor: Todd A. Hedman, Mokena, IL (US)

Correspondence Address: WALLENSTEIN & WAGNER, LTD., 311 SOUTH WACKER DRIVE, 53RD FLOOR, CHICAGO, IL, 60606, US

(21) Appl. No.: 11/256,913

(22) Filed: Oct. 24, 2005

(51) Int. Cl. F21V 33/00

(52) U.S. Cl. 362/96; 362/431; 362/656; 362/659; 362/228

(57) ABSTRACT

A landscape light and fluid delivery fixture is provided. The fixture is comprised of a lamp compartment adapted to receive a lighting element. The fixture also has a nozzle disposed above the lamp compartment. The fixture also includes a cover with an inner surface and an outer surface. The cover is positioned between the lamp compartment and the nozzle. The fixture further includes a fluid line having an inlet end and an outlet end coupled to the nozzle.

### CROSS-REFERENCE TO RELATED APPLICATIONS

None.

### TECHNICAL FIELD

The invention relates to a landscape lighting and fluid delivery system, and more particularly to a landscape light and watering fixture.

### BACKGROUND OF THE INVENTION

It is well known to install path and area lighting in a landscape design to provide needed safety aspects to the landscape design. However, it is often desirable that such lighting be a non-intrusive cast of light on walkways, beds of flowers, or the like that preserves the aesthetic feel and layout of the landscape design.

It is also often necessary to install sprinkler systems or watering units to maintain growth (e.g. flowers, plants, hedges etc.) incorporated into landscaping designs. As with lighting fixtures, it is often desirable that such systems be unobtrusive, yet still provide a wide coverage to maintain the growth of the landscape design. Because landscape designs are often constrained by predetermined property or natural boundaries, inclusion of both lighting and sprinkler fixtures to provide both adequate lighting and watering is often difficult, if not completely prohibitive.

The present invention is provided to solve the problems discussed above and other problems, and to provide advantages and aspects not provided by prior landscape fixtures. A full discussion of the features and advantages of the present invention is deferred to the following detailed description, which proceeds with reference to the accompanying drawings.

### SUMMARY OF THE INVENTION

According to the present invention, a landscape light and fluid delivery fixture is provided. The fixture is comprised of a lamp compartment adapted to receive a lighting element. The fixture also has a nozzle disposed above the lamp compartment. The fixture also includes a cover with an inner surface and an outer surface. The cover is positioned between the lamp compartment and the nozzle. Alternatively, the nozzle is disposed proximate a top portion of the cover. The fixture further includes a fluid line having an inlet end and an outlet end coupled to the nozzle.

According to another aspect of the present invention, the landscape light and fluid delivery fixture is comprised of an elongate member having a proximal end and a distal end. The fixture also includes a lamp compartment attached to the proximal end of the elongate member. The lamp compartment is provided to house a lighting element. The fixture includes a nozzle disposed above the lamp compartment, and a cover positioned between the lamp compartment and the nozzle and having an inner surface and an outer surface. The fixture also includes a fluid line having an inlet end and an outlet end. The outlet end is operably coupled to the nozzle.

According to another aspect of the present invention, the fixture also includes a stake removably coupled to the distal end of the elongate member. The stake is comprised of an outer housing and an insert.

According to another aspect of the present invention, a landscape light and fluid delivery system is provided. The system is operably coupled to a fluid source. The system is comprised of a fixture and a pump. The fixture is comprised of an elongate member, a lamp compartment, a nozzle, a cover, a fluid line. The lamp compartment is attached to a proximal end of the elongate member and includes a bulb socket adapted to receive a lighting element. The nozzle is disposed above the lamp compartment. The cover has an inner surface and an outer surface and is positioned between the lamp compartment and the nozzle. The fluid line has an inlet end and an outlet end. The outlet end is operably coupled to the nozzle. The pump is disposed between the fluid source and the inlet end of the fluid line.

According to still another aspect of the present invention, the system is actuatable between a high pressure setting and a low pressure setting. When the system is in the high pressure setting the system is adapted to emit a fog of fluid, and when the system is in the low pressure setting the system is adapted to emit a mist of fluid.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a landscape light and fluid delivery system according to the present invention;

FIG. 2 is a exploded cross-sectional view of the landscape light and fluid delivery fixture shown in FIG. 1;

FIG. 3 is a bottom partial perspective view of the landscape light and fluid delivery fixture shown in FIG. 1 illustrating a lamp compartment of the landscape light and fluid delivery fixture;

FIG. 4 is a partial cross-sectional view of the lamp compartment shown in FIG. 3;

FIG. 5 is a bottom partial perspective view of the landscape light and fluid delivery fixture illustrating another embodiment of a lamp compartment of the landscape light and fluid delivery fixture;

FIG. 6 and 6A are a partial cross-sectional view of another embodiment of the lamp compartment of the landscape light and fluid delivery fixture;

FIG. 7 is an enlarged partial cross-sectional view of the nozzle used in connection with landscape light and fluid delivery fixture shown in FIG. 1;

FIG. 8 is a exploded view of the stake used in connection with the landscape light and fluid delivery fixture shown in FIG. 1;

FIG. 9 is an cross-sectional view of the stake used in connection with landscape light and fluid delivery fixture shown in FIG. 6;

FIG. 10 is a perspective view of another embodiment of a landscape light and fluid delivery fixture according to the present invention; and,

FIG. 11 is a perspective view of another embodiment of a landscape light and fluid delivery fixture according to the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

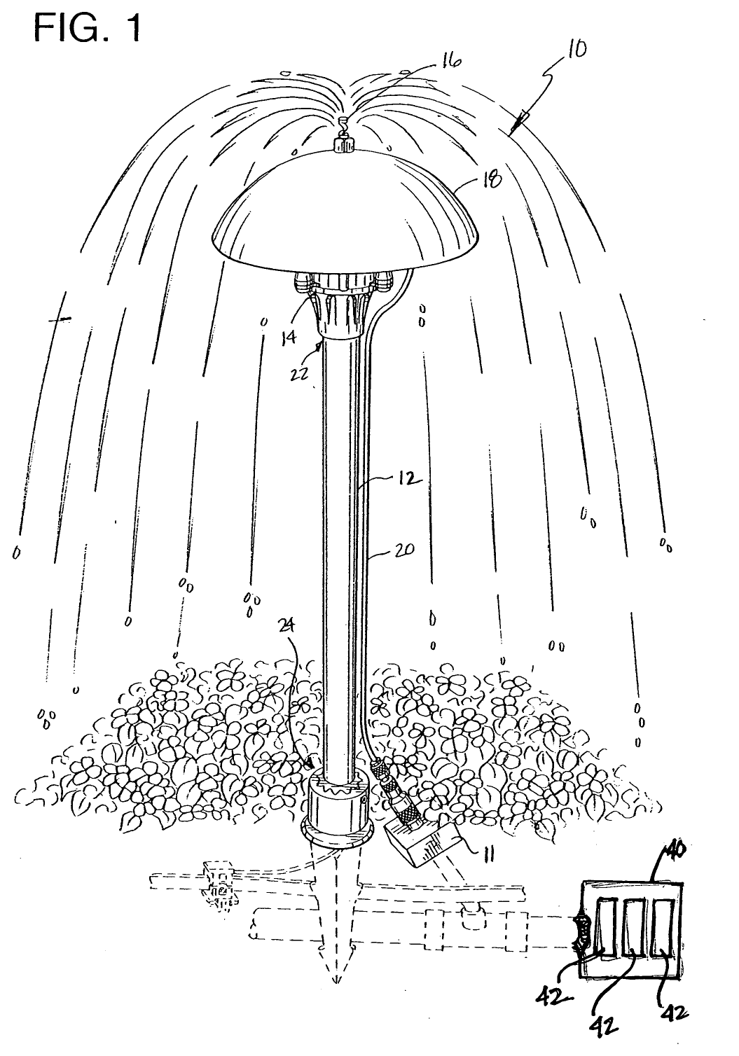

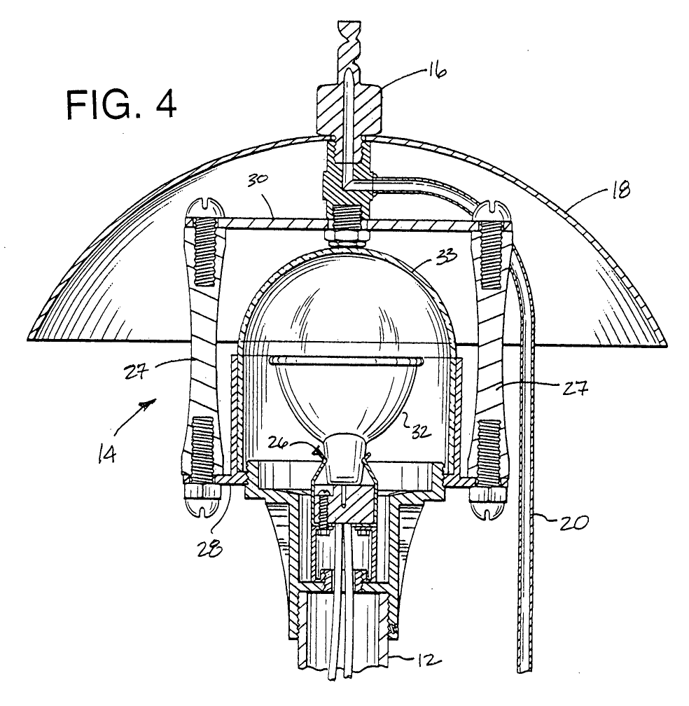

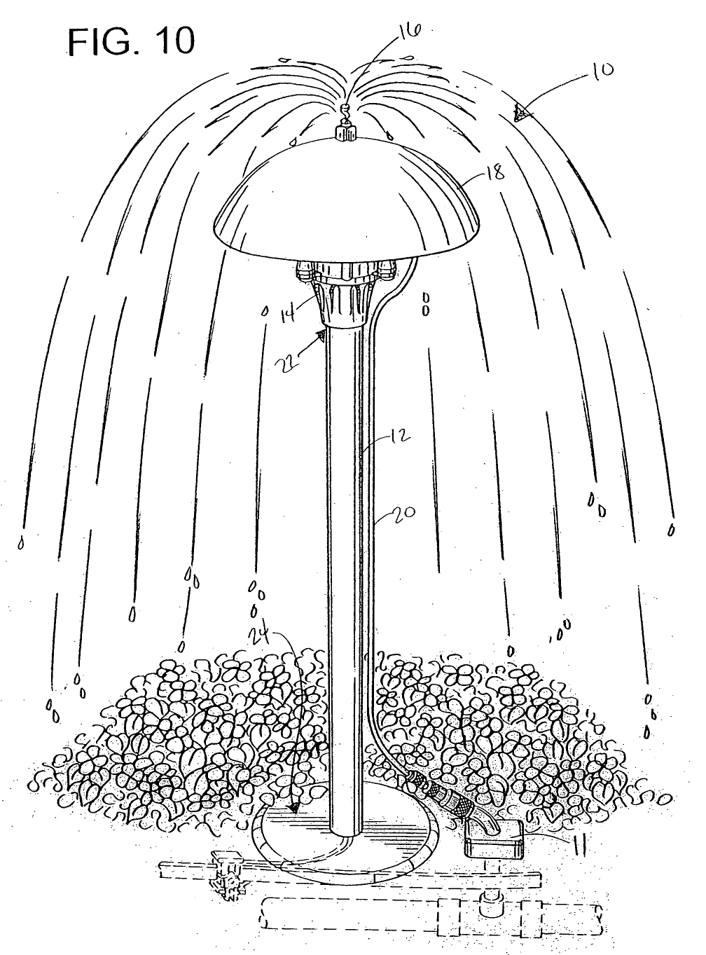

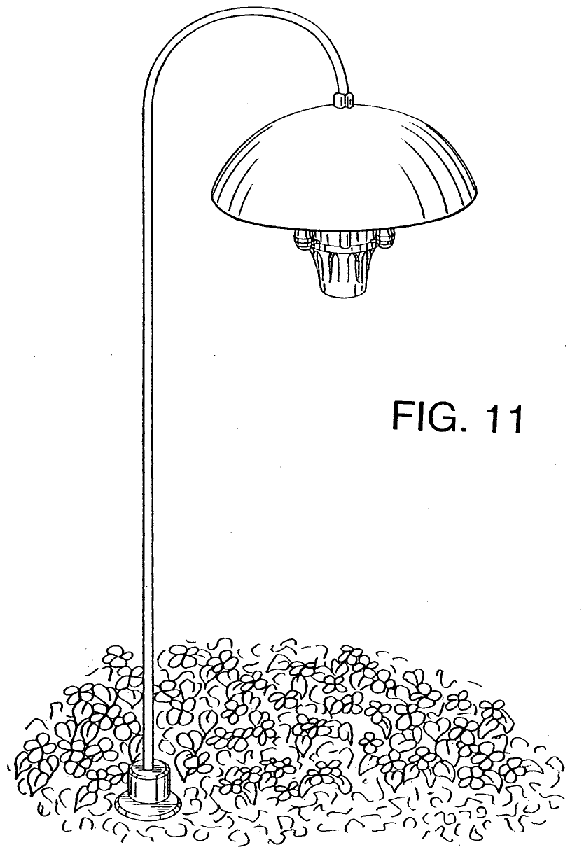

Referring now to FIGS. 1-11, a landscape light and fluid delivery system is provided. As will be described in detail below, the system generally includes a fixture 10 that is operably coupled to a fluid source and, when used in connection with high-pressure application, to a pump 11.

In one embodiment of the invention shown in FIGS. 1-9, the fixture is comprised of an elongate member 12, a lamp compartment 14, a nozzle 16, a cover 18 and a fluid line 20. The elongate member 12 has a proximal end 22 and a distal end 24. In one preferred embodiment, the elongate member 12 is a generally hollow shaft suitable to accommodate electrical wiring running from the lamp compartment 14 to a power source (not shown). Accordingly, the elongate member 12 assists in both organizing and protecting the electrical wiring from damage due to wear, weather or other similar causes.

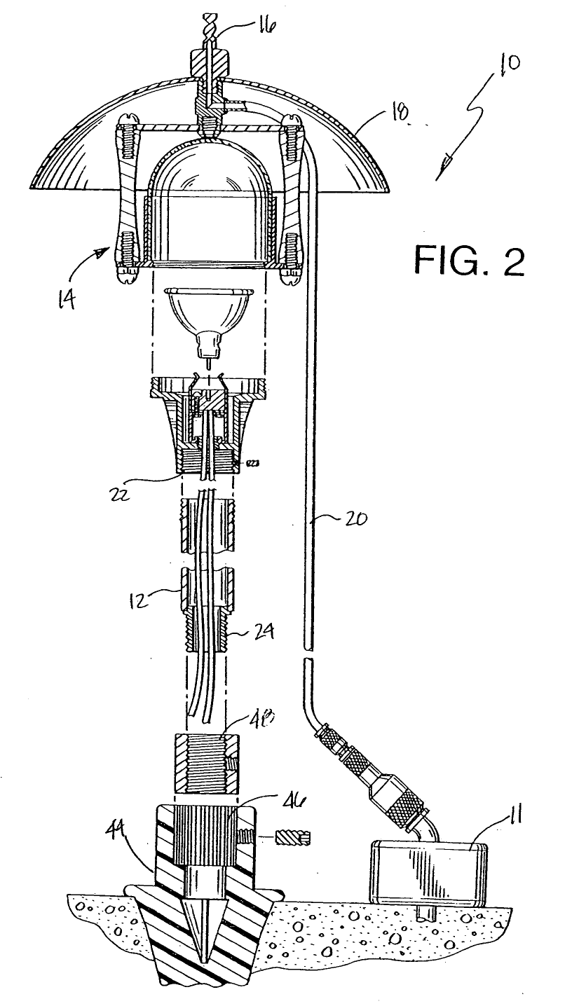

As illustrated in FIG. 2, at least one, and preferably both the proximal and distal ends 22, 24 of the elongate member 12 are threaded. Because copper is particularly suited to resist rust in varying climate conditions, the elongate member 12 of the fixture 10 is preferably formed from copper. However, the elongate member 12 may be formed from any suitable material, including brass, stainless steel, aluminum, plastic or composites, without departing from the present invention.

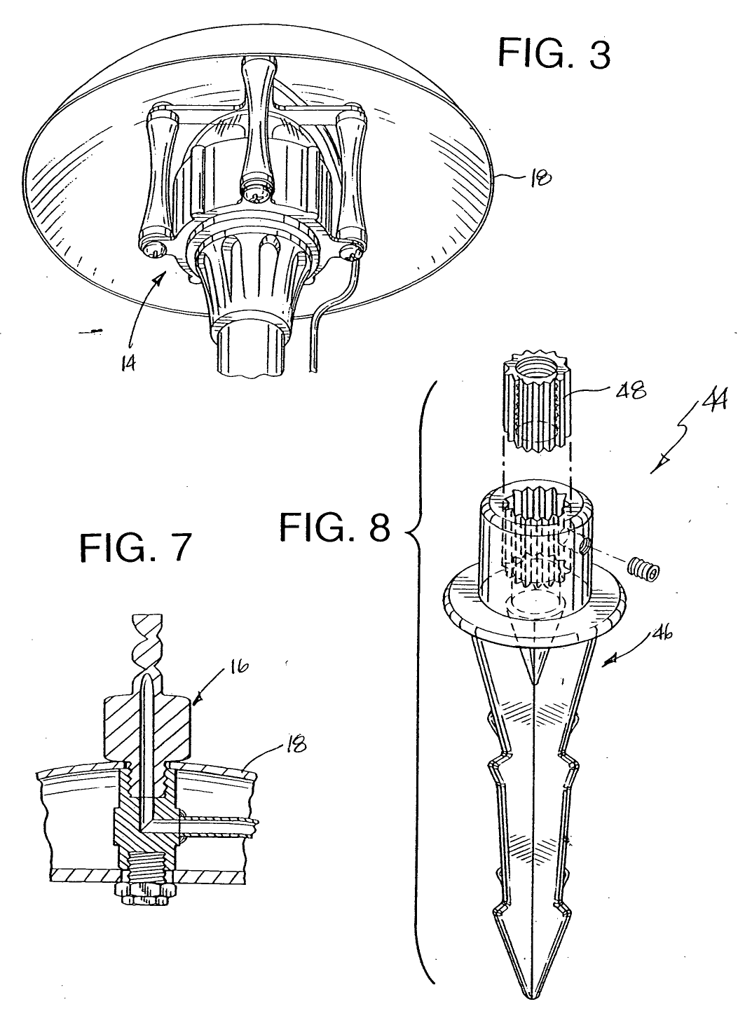

In one preferred embodiment shown in FIGS. 3-6, the lamp compartment 14 is removably coupled to the proximal end 22 of the elongate member 12 and provided to house a lighting element 32. As discussed above, a portion of the lamp compartment 14 preferably includes threading that cooperatively corresponds with threading on the proximal end 22 of the elongate member 12. Although the lamp compartment 14 of the embodiment of the invention shown in FIG. 3 is removably coupled to the elongate member 12, it will be understood that the lamp compartment 14 may be more permanently affixed to the elongate member 12 or alternatively coupled to the elongate member 12 by other suitable means, such as, by way of example, a horizontal bolt, pin, fastener or weld.

As shown in FIGS. 3-6, the lamp compartment 14 is comprised of a bulb socket 26, a lamp base 28 and a lamp cap 30. The bulb socket 26 may be of any type suitable for receiving a light bulb used in a particular landscaping application. As such, the bulb socket 26 may be of the kind suitable for receiving a halogen bulb, or alternatively a filament bulb. It is preferred that the base 28 and cap 30 of the lamp compartment 14 be formed from brass. However, it will be understood that any suitable materials may be used without departing from the present invention.

The bulb socket 26 of the lamp compartment 14 is adapted to receive a lighting element 32, such as for example a filament light bulb, a halogen bulb or any other lighting element 32 suitable for use in landscaping fixtures. The base 28 is connected to the bulb socket 26 proximate the lower surface of the bulb socket 26. The cap 30 is coupled to the base 28 by at least one connector 27. In one embodiment of the invention, the lamp compartment 14 also includes a substantially water-resistant, dust resistant, bug resistant and heat resistant shield 33 surrounding at least the lighting element 32. For example, the lamp compartment 14 may include a sealed glass or plastic shield 33 that surrounds or encapsulates the lighting element 32. The shield 33 is preferably a borosilicate or other shatter-resistant material.

The lighting element 32 may be powered by remote power source, such as, for example, through an electrical outlet. In such an embodiment, the lamp compartment 14 includes electrical wiring connected to the lighting element 32. As discussed above, the wiring is run through the elongate member 12 and exits the fixture 10 proximate the distal end 24 of the elongate member 12. In this manner, the elongate member 12 acts as a wire housing to protect the wires from damage and at least partially protected from fluid dispensed from the nozzle 16 of the fixture 10. Alternatively, the lighting element 32 may be powered by a local power source such as a battery, solar cells, transformer, electrical power or any other suitable mechanism for lighting elements 32. It is contemplated that the lighting element 32 be used in connection with both low voltage landscape lighting and line voltage (regular household current without transformer) landscape lighting.

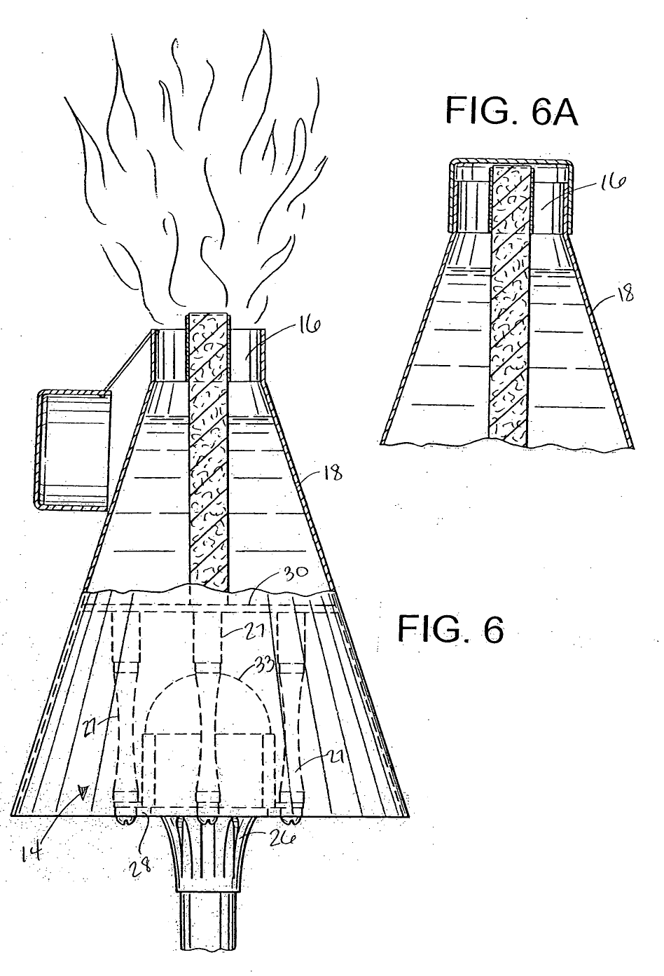

The fixture 10 according to the present invention also includes a nozzle 16 and a light compartment cover 18. Preferably, the nozzle 16 is generally disposed above the lamp compartment 14 and the cover 18 is positioned between the lamp compartment 14 and the nozzle 16. Alternatively, the nozzle 16 may be disposed proximate a top portion of the cover 18, for example as shown in FIG. 6, in a recess within the cover 18. Although the cover 18 is preferably copper or copper plated, it is contemplated that the outer surface be any material suitable for use in landscaping or landscape lighting applications. As shown in FIG. 1, the cover 18 is preferably a dome that generally covers a portion of the lamp compartment 14. It will be understood, however, that the cover 18 may be any shape suitable for preserving the aesthetic appearance of the fixture 10, while also providing a cascading surface that assists in protecting the lighting element 32 from fluid being dispensed from the nozzle 16.

The fixture 10 of the present invention further includes a fluid line 20. The fluid line 20 has an inlet end 34 and an outlet end 36, and is preferably made from ⅛ inch diameter copper tubing. However, it is contemplated that the fluid line 20 be made from any material suitable for facilitating the flow of fluid from a fluid source to the nozzle 16. It is also contemplated that the diameter of the fluid line 20 be any diameter suitable for the size of the nozzle 16, and the application for which the fixture 10 is being employed. The outlet end 36 of the fluid line 20 is coupled to the nozzle 16. The inlet end 34 of the fluid line 20 is coupled to a fluid source such as, for example, a consumer water spigot or a tank 40 that contains water, pesticides, scented solutions, fertilizer or other fluids used in connection with landscaping and gardening applications.

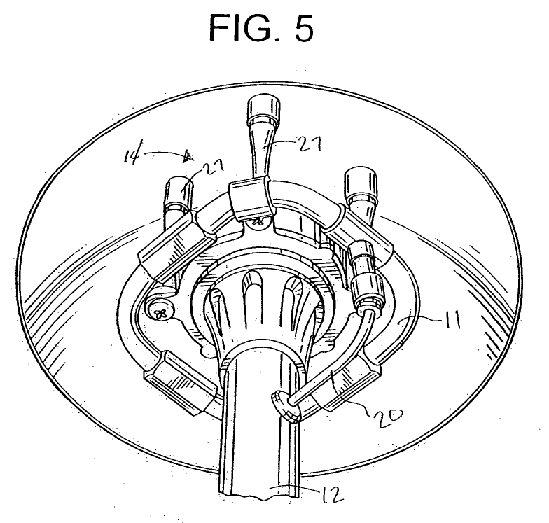

According to one embodiment of the invention shown in FIG. 5, the fixture 10 may include a second fluid line 20 that extends through the elongate member 12. According to such an embodiment, the second fluid line 20 is made from ⅛ inch nylon that feeds fluid to the nozzle 16 in place of the copper line on the outside as described above. In such an embodiment, the fluid line 20 extending external to the elongate member 12 may be used for easy retrofits to existing landscape fixtures, and the second nylon fluid line 20 will exit through the wall of the elongate member 12 through a rubber grommet near the top of the pipe just below the lamp compartment 14 and attach in the same manner. The second line 20 exits the distal end bottom of the elongate member 12 stem.

According to one embodiment, the fixture 10 includes a coupling member 38 generally provided to couple the lamp compartment 14 to the nozzle 16, and to provide a channel to direct the fluid to be dispensed from the fluid line 20 to the nozzle 16. The first end of the coupling member 38 is coupled to the lamp compartment 14 and the second end of the coupling member 38 is coupled to the nozzle 16. The cover 18 is disposed between the nozzle 16 and the second end of the coupling member 38. In one preferred embodiment, the coupling member 38 is a threaded double-female coupler adapted to receive respective corresponding threaded portions of the nozzle 16 and the lamp compartment 14. The coupling member 38 has a first end, a second end and an aperture in a sidewall thereof for receiving a portion of the fluid line 20. Preferably, the fluid line 20 is soldered directly into the aperture of the coupling member 38. However, it is contemplated that the fluid line 20 be operably secured within the aperture by any suitable means, including sealant, connector or other connecting methods as will be known by those of skill.

It is often desirable to dispense fluid through the fixture 10 at high pressures to provide greater coverage to larger landscaped areas; or to dispense the fluid in an alternative form such as, for example, in a cooling fog. Thus, according to one embodiment of the present invention, the inlet end 34 of the fluid line 20 is connected to a pump 11 that is operably coupled to the fluid source. As discussed above, the fixture 10 emits a fog of fluid in the high pressure setting. When the pump 11 is in the low pressure setting, the fixture 10 emits a mist of fluid.

It is also contemplated that the fixture 10 can be attached to a selectable fluid storage tank 40. According to this embodiment, the storage tank 40 is capable of storing a plurality of fluids. For example, the tank 40 may be adapted to simultaneously, or alternatively, interchangeably receive a plurality of liquid cartridges 42 with each of the cartridges 42 containing a different fluid. For example, the tank 40 may include slots for receiving four cartridges 42, wherein one of the cartridges 42 contains water, a second cartridge 42 contains fertilizer, a third cartridge 42 contains pesticides, and a fourth cartridge 42 contains fragrances. Alternatively, the tank 40 may include a single slot for receiving a single cartridge 42. The tank 40 includes an actuator for selectively delivering one of the plurality of fluids.

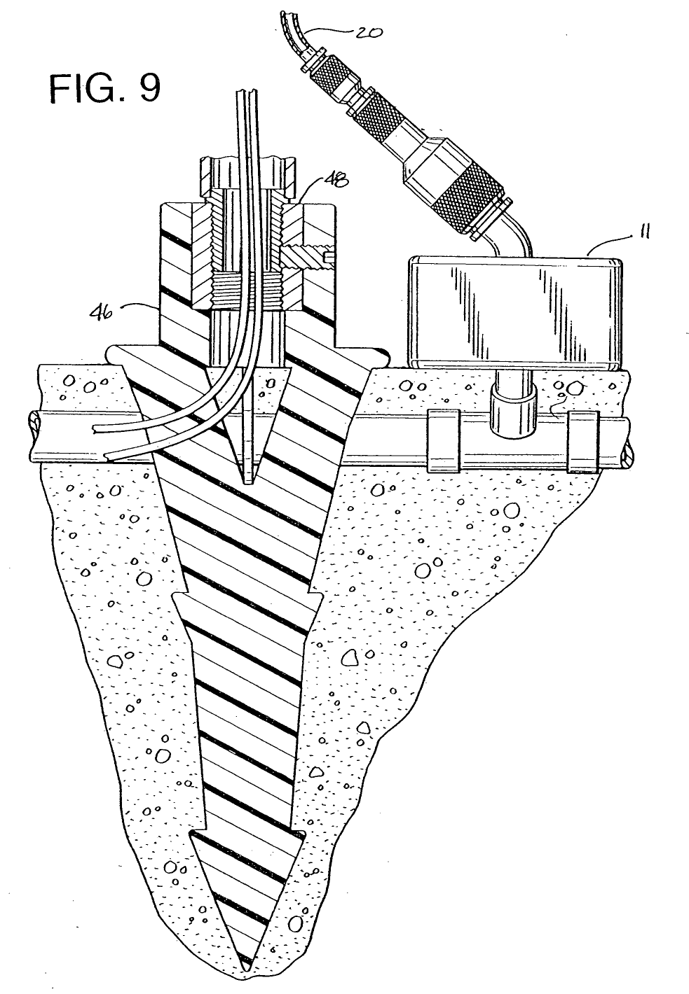

According to one embodiment of the present invention, the fixture 10 also includes a stake removably coupled to the distal end 24 of the elongate member 12. The stake 44 provides a mechanism for penetrating the ground in which the fixture 10 may be placed. As shown in FIGS. 8 and 9, the stake is comprised of an outer housing 46 and an insert 48. The insert 48 is preferably a threaded metal member adapted to securably receive the distal end 24 of the elongate member 12. According to one embodiment, the insert 48 is configured in a sun-like pattern to deter loose spinning of the insert 48 after extended use. The outer housing 46 forming the shape of the stake 44 is preferably a polymer. More particularly, the insert is preferably formed from brass and the outer housing is preferably formed from a hardened plastic. The outer housing 46 of the stake 44 preferably includes some serration to assist in securing the fixture 10 in the ground or other such surface or a mount that allows the fixture 10 to be bolted, screwed attached to concrete or other surfaces for flush mounting (as opposed to stake mounting).

According to other embodiments of the present invention, the fixture 10 may be connected to a platform base. Thus, the fixture 10 may be moved from location to location. Alternatively, the fixture 10 may be configured to be suspended. According to such an embodiment the fixture 10 may not include an elongate member 12, but will instead include an attachment point that allows the fixture 10 to be suspended above a target location.

As used herein, the terms “first,” “second,” “third,” etc. are for illustrative purposes only and are not intended to limit the embodiments in any way. Additionally, the term “plurality” as used herein is intended to indicate any number greater than one, either disjunctively or conjunctively as necessary, up to an infinite number.

While the specific embodiments have been illustrated and described, numerous modifications come to mind without significantly departing from the spirit of the invention, and the scope of protection is only limited by the scope of the accompanying Claims.

What is claimed is:

1. A landscape light and fluid delivery fixture comprising:
a lamp compartment adapted to receive a lighting element;
a nozzle disposed above the lamp compartment;
a cover having an inner surface and an outer surface; and,
a fluid line having an inlet end and an outlet end, the outlet end being coupled to the nozzle.

2. The fixture of claim 1, further comprising a coupling member having a first end and a second end, the first end of the coupling member being coupled to the lamp compartment and the second end of the coupling member being coupled to the nozzle, the cover being disposed between the nozzle and the second end of the coupling member, the coupling member further comprising an aperture for receiving a portion of the water line.

3. The fixture of claim 1, the lamp compartment further comprising:
a bulb socket adapted to receive a lighting element;
a base connected to the bulb socket proximate the lower surface of the bulb socket; and,
a cap coupled to the base by at least one connector, the cap further including a centrally disposed coupling member.

4. The fixture of claim 3, wherein the lamp compartment further comprises a substantially water-resistant cover surrounding at least the lighting element.

5. The fixture of claim 1, wherein the cover is positioned between the lamp compartment and the nozzle.

6. The fixture of claim 1, wherein the cover includes a recess proximate a top portion of the cover, the nozzle being disposed within the recess.

7. A landscape light and fluid delivery fixture comprising:
an elongate member having a proximal end and a distal end;
a lamp compartment attached to the proximal end of the elongate member and provided to house a lighting element;
a nozzle disposed above the lamp compartment;
a cover having an inner surface and an outer surface; and,
a fluid line having an inlet end and an outlet end, the outlet end being coupled to the nozzle.

8. The fixture of claim 7, further comprising a coupling member having a first end and a second end, the first end of the coupling member being coupled to the lamp compartment and the second end of the coupling member being coupled to the nozzle, the cover being disposed between the nozzle and the second end of the coupling member, the coupling member further comprising an aperture for receiving a portion of the water line.

9. The fixture of claim 7, the lamp compartment further comprising:
a bulb socket adapted to receive a lighting element;
a base connected to the bulb socket proximate the lower surface of the bulb socket; and,
a cap coupled to the base by at least one connector, the cap further including a centrally disposed coupling member.

10. The fixture of claim 9, wherein the lamp compartment further comprises a substantially water-resistant cover surrounding at least the lighting element.

11. The fixture of claim 9, wherein the lamp compartment is removably coupled to the proximal end of the elongate member.

12. The fixture of claim 11, wherein at least one of the proximal and distal ends of the elongate member are threaded.

13. The fixture of claim 7, further comprising a stake coupled to the distal end of the elongate member.

14. The fixture of claim 13, wherein the stake is removably coupled to the distal end of the elongate member.

15. The fixture of claim 13, wherein the stake comprises an outer housing and an insert, the insert being adapted to securably receive the distal end of the elongate member.

16. The fixture of claim 15, wherein the outer housing is formed from a polymer and the insert is formed from metal.

17. A landscape light and fluid delivery system operably coupled to a fluid source, the system comprising:
a fixture comprising:
an elongate member having a proximal end and a distal end;
a lamp compartment attached to the proximal end of the elongate member, the lamp compartment including a bulb socket adapted to receive a lighting element;
a nozzle disposed above the lamp compartment;
a cover having an inner surface and an outer surface, the nozzle being disposed proximate a top portion of the cover;
a fluid line having an inlet end and an outlet end, the outlet end being operably coupled to the nozzle; and,
a pump disposed between the fluid source and the inlet end of the fluid line.

18. The system of claim 17, wherein the system is actuatable between a high pressure setting and a low pressure setting, wherein when the system is in the high pressure setting the system is adapted to emit a fog of fluid, and wherein when the system is in the low pressure setting the system is adapted to emit a mist of fluid.

19. The system of claim 18, further comprising:
a tank adapted to separately store and dispense a plurality of fluids; and,
an actuator for selectively delivering one of the plurality of fluids.
